(19) United States
(12) Patent Application Publication
(10) Pub. No.: US 2026/0303593 A1
(43) Pub. Date: Oct. 1, 2026

(54) TECHNIQUES FOR VERIFYING USERS IN A CONTENT STREAM

(71) Applicant: Lenovo (United States) Inc., Morrisville, NC (US)

(72) Inventors: John W. Nicholson, Cary, NC (US); Rafael Marius Radkowski, Apex, NC (US); Chunbo Song, Arlington, VA (US); Barrett Bryson, Raleigh, NC (US)

(21) Appl. No.: 19/094,646

(22) Filed: Mar. 28, 2025

(51) Int. Cl. H04L 9/40; H04L 12/18

(52) U.S. Cl. CPC H04L 63/0861; H04L 12/1822

(57) ABSTRACT

Apparatuses, methods, and systems are disclosed for techniques for verifying users in a content stream. An apparatus is configured to register at least one reference image associated with a first user, receive an input content stream comprising at least one image of a second user, verify that the at least one reference image associated with the first user matches the at least one image of the second user, generate an output content stream comprising an artificial intelligence composition of the at least one reference image associated with the first user and the input content stream, and output the output content stream.

### FIELD

The subject matter disclosed herein relates to computing devices and more particularly relates to techniques for verifying users in a content stream.

### BACKGROUND

Video conferencing has been proven to be a useful and essential tool for businesses namely for online meetings, interviews, conferences, and various online interactions such as instruction, lectures, and discussions. Video conferencing implements various tools and effects such as blurring and changing the background of the video.

### BRIEF SUMMARY

An apparatus for techniques for verifying users in a content stream is disclosed. A method and system also perform the functions of the apparatus. In one embodiment, an apparatus includes a processor and a memory that stores code that is executable by the processor. In one embodiment, the code is executable by the processor to register at least one reference image of a first user, receive an input content stream containing at least one image of a second user, verify the input content stream matches the at least one reference image, generate an output content stream which includes an artificial intelligence composition of the at least one reference image and the input content stream, and output the generated output content stream.

In one embodiment, a method for verifying users in a content stream includes registering at least one reference image associated with a first user, receiving an input content stream comprising at least one image of a second user, in response to verifying that the at least one reference image associated with the first user matches the at least one image of the second user, generating an output content stream comprising an artificial intelligence composition of the at least one reference image associated with the first user and the input content stream, and outputting the output content stream.

In one embodiment, a computer program product for verifying users in a content stream includes a nontransitory computer readable storage medium storing code. The code is executable by a processor to perform operations including to register at least one reference image associated with a first user, to receive an input content stream comprising at least one image of a second user, to verify that the at least one reference image associated with the first user matches the at least one image of the second user, to generate an output content stream comprising an artificial intelligence composition of the at least one reference image associated with the first user and the input content stream, and to output the output content stream.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for techniques for verifying users in a content stream, in accordance with the subject matter disclosed herein;

FIG. 2 is a schematic block diagram illustrating one embodiment of an apparatus for techniques for verifying users in a content stream, in accordance with the subject matter disclosed herein;

FIG. 3 is a schematic block diagram illustrating one embodiment of an apparatus for techniques for verifying users in a content stream, in accordance with the subject matter disclosed herein;

FIG. 4 is a schematic block diagram illustrating one embodiment of an apparatus for techniques for verifying users in a content stream, in accordance with the subject matter disclosed herein;

FIG. 5 is a schematic block diagram illustrating one embodiment of a registration module of an apparatus for techniques for verifying users in a content stream, in accordance with the subject matter disclosed herein;

FIG. 6 is a schematic block diagram illustrating one embodiment of an input content stream module of an apparatus for techniques for verifying users in a content stream, in accordance with the subject matter disclosed herein;

FIG. 7 is a schematic block diagram illustrating one embodiment of a system for techniques for verifying users in a content stream, in accordance with the subject matter disclosed herein;

FIG. 8 is a schematic flow chart diagram illustrating one embodiment of a method for techniques for verifying users in a content stream, in accordance with the subject matter disclosed herein;

FIG. 9 is a schematic flow chart diagram illustrating one embodiment of a method for techniques for verifying users in a content stream, in accordance with the subject matter disclosed herein; and

FIG. 10 is a schematic flow chart diagram illustrating one embodiment of a method for techniques for verifying users in a content stream, in accordance with the subject matter disclosed herein.

### DETAILED DESCRIPTION

As will be appreciated by one skilled in the art, aspects of the embodiments may be embodied as an apparatus, system, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object oriented programming language such as Python, Ruby, R, Java, Java Script, Smalltalk, C++, C sharp, Lisp, Clojure, PHP, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The embodiments may transmit data between electronic devices. The embodiments may further convert the data from a first format to a second format, including converting the data from a non-standard format to a standard format and/or converting the data from the standard format to a non-standard format. The embodiments may modify, update, and/or process the data. The embodiments may store the received, converted, modified, updated, and/or processed data. The embodiments may provide remote access to the data including the updated data. The embodiments may make the data and/or updated data available in real time. The embodiments may generate and transmit a message based on the data and/or updated data in real time. The embodiments may securely communicate encrypted data. The embodiments may organize data for efficient validation. In addition, the embodiments may validate the data in response to an action and/or a lack of an action.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise. The term “and/or” indicates embodiments of one or more of the listed elements, with “A and/or B” indicating embodiments of element A alone, element B alone, or elements A and B taken together.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generative artificial intelligence (AI) models enable “deep fake” impersonations. These technological advances invite potential impersonations by allowing users to use paintings, cartoons, and photographs to be warped or transformed to a user's face. The apparatuses, systems, and methods described herein prevent potential impersonations by authenticating a user and a registered profile and a corresponding reference image.

In some embodiments, the apparatuses, systems, and/or methods of verifying users in a content stream include a continuous verification that the individual of the input content stream and the reference image are the same person. The apparatuses, systems, and/or methods ensure that the individual in the reference image is the user and not an impersonator.

In one embodiment, the apparatuses, systems, and/or methods are started automatically when a camera or video conferencing application is activated or executed. In one embodiment, the apparatuses, systems, and/or methods are part of a user-controlled camera feature. In another embodiment, the apparatuses, systems, and/or methods may be separate applications that use the camera.

In one embodiment, an apparatus includes a processor and a memory that stores code that is executable by the processor. In one embodiment, the apparatus is configured to register at least one reference image associated with a first user, receive an input content stream including at least one image of a second user, in response to verifying the at least one reference image associated with the first user matches the at least one image of the second user, generate an output content stream including an artificial intelligence composition of the at least one reference image associated with the first user and the input content stream, and output the output content stream.

In one embodiment, the apparatus is configured to register the at least one reference image by uploading the at least one reference image from the memory. In one embodiment, the apparatus is configured to enhance the input content stream to match an image quality of the at least one reference image associated with the first user.

In one embodiment, the apparatus is configured to receive biomarker information for the first user and register the biomarker information by associating the biomarker information with the at least one reference image associated with the first user. In one embodiment, the biomarker information comprises a voice recording of the first user. In one embodiment, the biomarker information comprises a fingerprint of the first user.

In one embodiment, the apparatus is configured to verify that the at least one reference image associated with the first user matches the at least one image of the second user by performing a facial recognition comparison of the at least one reference image associated with the first user and the at least one image of the second user.

In one embodiment, the input content stream is captured using a local camera device of the apparatus. In one embodiment, the artificial intelligence composition further comprises a map overlay of the at least one reference image associated with the first user and the input media stream. In one embodiment, the artificial intelligence composition further comprises a selection of the at least one reference image to be used in the map overlay.

In one embodiment, the apparatus is configured to generate an error message, output the input content stream, or a combination thereof, in response to the at least one reference image associated with the first user not matching the at least one image of the second user.

In one embodiment, the apparatus is configured to continuously verify that the second user is visible in the input content stream. In one embodiment, the apparatus is configured to output the at least one reference image to the output content stream in response to the second user not being visible in the input content stream.

In one embodiment, the apparatus is configured to continuously verify that the at least one reference image associated with the first user matches the at least one image of the second user. In one embodiment, the apparatus is configured to periodically verify that the at least one reference image associated with the first user matches the at least one image of the second user.

In one embodiment, the apparatus is configured to register at least one reference image associated with a third user, detect that the input content stream further comprises at least one image of a fourth user, verify that the at least one reference image associated with the third user matches the at least one image of the fourth user, and enhance the output content stream by creating an artificial intelligence composition of the at least one reference image associated with the third user and the input content stream.

In one embodiment, a method includes registering at least one reference image associated with a first user, receiving an input content stream including at least one image of a second user, verifying the at least one reference image associated with the first user matches the at least one image of the second user, generating an output content stream includes an artificial intelligence composition of the at least one reference image associated with the first user and the input content stream, and outputting the output content stream.

In one embodiment, the method further includes taking the at least one reference image using a local camera device. In one embodiment, registering further includes a biomarker associated with the first user.

In one embodiment, a computer program product includes a nontransitory computer readable storage medium storing code, the code is configured to be executable by a processor to perform operations including registering at least one reference image associated with a first user, receiving an input content stream including at least one image of a second user, verifying the at least one reference image associated with the first user matches the at least one image of the second user, generating an output content stream including an artificial intelligence composition of the at least one reference image associated with the first user and the input content stream, and outputting the content stream.

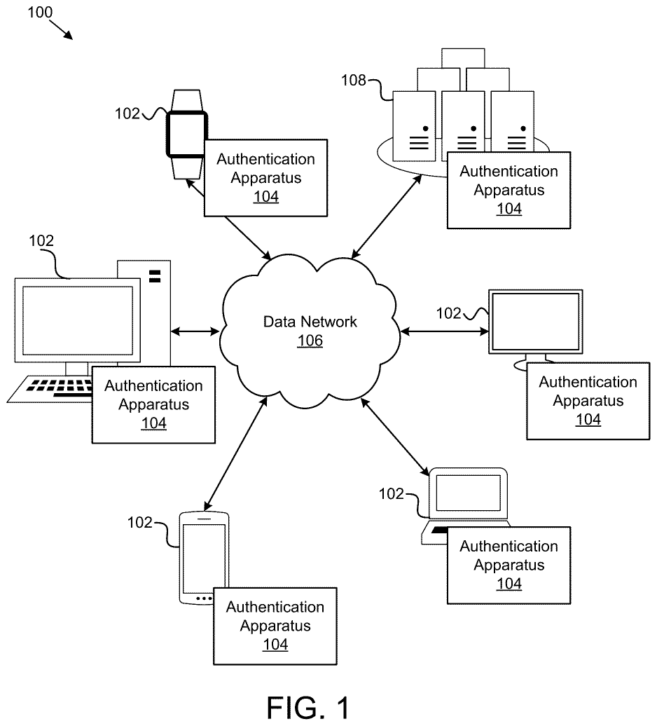

FIG. 1 is a schematic block diagram illustration one embodiment of a system 100 for techniques for verifying users in a content stream. In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In general, in one embodiment, the authentication apparatus 104 is configured to determine that a computing device is streaming an image or video to one or more computing devices through the data network 106. In some embodiments, the computing device is configured to stream video and/or audio for a video conference. As used herein, a video conference may refer to a live, virtual meeting where participants communicate via video and audio over the internet or a private network. It allows individuals or groups in different locations to interact in real time, often using computers, smartphones, or specialized video conferencing systems. There are various types of video conferencing such as one-to-one video conferencing, group video conferencing, webinars or web conferencing, telepresence video conferencing, remote and virtual workspaces, cloud-based video conferencing, and virtual reality (VR) video conferencing. There are also various types of applications that support video conferencing, including Zoom®, Microsoft Teams®, Google Meet™, Adobe Connect®, FaceTime®, WhatsApp® Video call, Facebook Messenger® Video, Snapchat® Video Call, Slack® Huddles, Discord® Video Calls, and many other video conferencing applications. The term video conference may, in some embodiments, include a visual recording of a user. These videos may be created ahead of time to be used in various video conferences such as webinars and training videos.

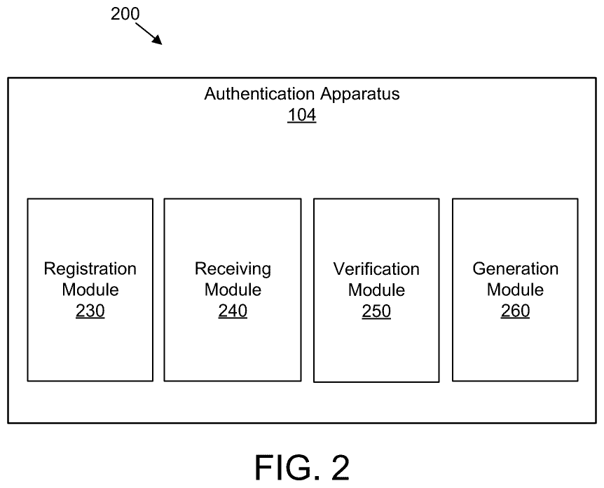

As described in more detail below, in one embodiment, an authentication apparatus 104 is configured to register at least one reference image associated with a first user, receive an input content stream including at least one image of a second user, verify the at least one reference image associated with the first user matches the at least one image of the second user, generate an output content stream includes an artificial intelligence composition of the at least one reference image associated with the first user and the input content stream, and output the output content stream. In some embodiments, the authentication apparatus 104 can process image or video data captured by the camera device 102 to create an input content stream and the authentication apparatus 104 can modify the input content stream using artificial intelligence tools to generate an output content stream. The authentication apparatus 104 is described in more detail below with reference to FIGS. 2 through 4.

In certain embodiments, the authentication apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the authentication apparatus 104 may include a power interface, a wired and/or wireless network interface, a graphical interface that attaches to a display, and/or a semiconductor integrated circuit device as described below, configured to perform the functions described herein with regard to the authentication apparatus 104.

The authentication apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the authentication apparatus 104 may include a camera which is mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the camera within the authentication apparatus 104.

The semiconductor integrated circuit device or other hardware appliance of the authentication apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the authentication apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may be configured to execute, stream, transmit, or the like video conferencing algorithms, programs, applications, processes, and/or the like.

FIG. 2 is a schematic block diagram illustrating one embodiment of an apparatus 200 for techniques for verifying users in a content stream. In one embodiment, the apparatus 200 includes an instance of an authentication apparatus 104. In one embodiment, the authentication apparatus 104 includes one or more of a registration module 230, a receiving module 240, a verification module 250, and a generation module 260, which are described in more detail below.

In one embodiment, the registration module 230 is configured to select, determine, access, receive, and/or the like, a reference image to be associated with a user. In some embodiments, a reference image may be an image of the user that shows the user's face, either whole or at least in part. In another embodiment, a reference image refers to a compilation of multiple images of a user's face to create a composite image. Additional and alternate embodiments of the registration module 230 are described in more detail below.

In one embodiment, a receiving module 240 receives an input content stream. In one embodiment, the input content stream includes a video stream of a user. In one embodiment, a receiving module 240 includes, or is coupled with, at least a camera device. In another embodiment, the receiving module 240 includes, or is coupled with, several audio and visual devices to create an input content stream. Additional embodiments of the receiving module 240 are described in more detail below.

In one embodiment, a verification module 250 is configured to verify whether the user of the input content stream is the same individual as the registered user. In one embodiment, the verification module 250 includes the use of facial comparison tools to compare the reference image to at least one image from an input content stream. Upon verification by the verification module 250 that the user from the input content stream is the registered user, the input content stream and the reference image is sent, or otherwise made accessible, to the generation module 260. Additional embodiments of the verification module 240 are described in more detail below.

In one embodiment, a generation module 260 is configured to generate an output content stream that includes at least one AI composition which includes a modification to the input content stream to create and output an output content stream. As used herein, an AI composition may refer to a visual composition, such as image or video, which has been created or generated with the assistance of artificial intelligence. In some instances, the AI composition is generated based on, involves, or otherwise incorporates user inputs for refinement. In one embodiment, the at least one AI composition of the generation module 260 includes a modification of the input content stream to have a similar appearance to the reference image. The modification may include any number of changes such as facial animations of the reference image to match the facial expressions of the user in the input content stream. In one embodiment, the at least one AI composition includes a modification of the hair, clothing, and accessories of the user in the input stream such that the generation module 260 generates an output stream in which the user of the input content stream has the same appearance as the registered reference image. Additional embodiments of the generation module 260 are described in more detail below.

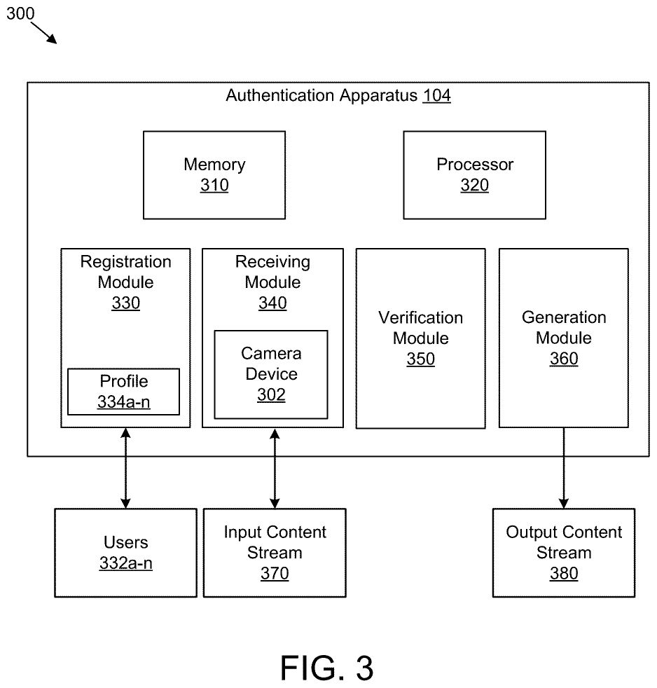

FIG. 3 is a schematic block diagram illustrating one embodiment of an apparatus 300 for techniques for verifying users in a content stream. In one embodiment, the apparatus 300 includes an instance of an authentication apparatus 104. In one embodiment, the authentication apparatus 104 includes one or more of a memory 310, a processor 320, a registration module 330, a receiving module 340, a verification module 350, and a generation module 360.

In one embodiment, the registration module 330 is configured to create and store at least one user profile 334 using at least one reference image 336a. A user profile 334 may refer, in some embodiments, to a collection of settings, files, and preferences associated with a specific user account. A user profile 334 may include a username, password, account type, and one or more reference images. In one embodiment, the user profile 334 is connected to the device account settings, e.g. directly tied to a username and password of a computing device. In some embodiments, a user profile 334 may refer to a local profile which is stored on the computer's hard drive and accessible only on that device. In another embodiment, the user profile 334 is a roaming profile, or a profile that is stored on a network server, allowing users to access their profile on a number of different computers. In some embodiments, the user profile 334 is a temporary profile and is valid until a user logs out in which case all settings are lost after logging out or disconnecting from the video conference. In one embodiment, the registration module 330 has access to memory 310 that stores one or more images of users 332a-n and potential users 332n-z. The registration module 330, in one embodiment, is configured to register the at least one reference image 336a by uploading the reference image 336a from the memory 310 to the registration module 330. In one embodiment, the uploaded reference image 336a may further be registered to a user profile 334a.

In one embodiment, the registration module 330 is configured to select a reference image 336a to create a user profile 334a for a user 332a. In such an embodiment, the registration module 330 may present a graphical user interface (GUI) or other interface for a user to indicate the desired reference image 336a. In another embodiment, the registration module 330 provides an interface for a user 332a to select and store multiple reference images 336a-n to be associated with the user's profile 334a. In one embodiment, the registration module 330 is configured to capture the at least one reference image 336a from a local camera device 302. In one embodiment, the reference image 336a is a compilation of images that are used to form a three dimensional (3D) facial model of the user 332a. In another embodiment, the reference image 336a refers to a facial recognition model rather than a particular image of the user.

In one embodiment, the registration module 330 is configured to register at least one reference image 336a and at least one biomarker to be associated with a user 332. The at least one biomarker may be any form of biometric information. In one embodiment, the biomarker is a fingerprint. In one embodiment, the biomarker is a voice recording for the user 332a. In an alternative embodiment, the biomarker includes a capture of the user's face using facial recognition registration. In one embodiment, the biomarker information includes an electronic biomarker, e.g., a signal or other identifier associated with a user's device, retinal scan, or any bioinformatic information that can be captured by a computing device. In some examples, the computing device may include a smart watch, a pacemaker, monitor, or any computing device that can capture and share biomarker information to the registration module 330. In one embodiment, the registration module 330 is configured to create and store a user's profile 334a based on at least one reference image 336a and at least one biomarker.

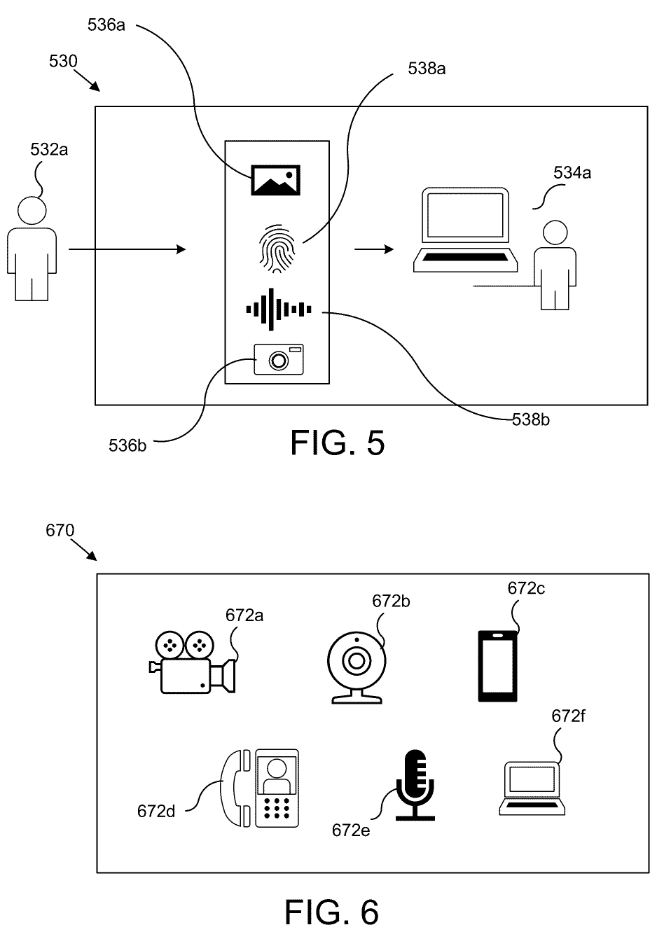

In yet another embodiment, the registration module 330 is configured to create and store a user's profile 334a based on at least one reference image 336a and a user input, e.g., a password, personal identification number (PIN), or multi-factor authentication. FIG. 5 illustrates one embodiment of a registration module 330 of an apparatus 104 for techniques for verifying users in a content stream. In one embodiment, a user 532a triggers the registration module 330 within an authentication apparatus 104 or within a video conferencing application. The registration module 530 registers at least one reference image 536a by selecting a reference image 536a (e.g., based on user input) and/or by capturing a reference image 536b of the user 532a by using a local camera 302. The registration module 530 may further include the registration of one or more biomarkers 538a-b from the user 532a, e.g., a fingerprint 538a and/or a voice recording 538b. Upon completion of registering at least one reference image 536a-b, and/or a biomarker 538a-b, the user 532a creates a user profile 534a to be used by the authentication apparatus 104 or in future video conferencing applications.

Referring back to FIG. 3, in one embodiment, the registration module 330 includes a database of multiple user profiles 334a-n wherein each user profile 334a-n includes at least one reference image 336a-n. In one embodiment, the database is a local database and in other embodiments the database is located in cloud storage or an external server.

In one embodiment, a receiving module 340 receives an input content stream 370 from an external video device. In one embodiment, the input content stream 370 includes a video stream of a user 332b. In one embodiment, a receiving module 340 includes, or is connected to, a local camera device 302 to capture an input content stream 370. In one embodiment, the input content stream 370 is created by a compilation of several audio and visual devices. As shown in FIG. 6, an input content stream 670 can be created by using a multitude of devices 672a-n. For example, the input content stream 670 may be captured by at least one device such as a video camera 672, a web camera 672b, a cellular device 672c, a telephone system 672d, a microphone 672e, and/or a laptop 672f. In one embodiment, the input content stream 670 may be created by a user 332b using a web camera 672b for visual content and a telephone system 672b for audio content. In yet another embodiment, the input content stream 670 is created by audio and visual capture by a laptop 672f and the sound is enhanced by using a secondary audio device, e.g. an external microphone 672e.

In one embodiment, a verification module 350 receives or accesses the registered profile 334a and/or the reference image 336a from the registration module 330 and receives or accesses the input content stream 370 from the receiving module 340. In one embodiment, the verification module 350 compares the registered profile 334a to the input content stream 370. For instance, the verification module 350 compares the at least one reference image 336a to at least one image of user 332b from the input content stream 370. The verification module 350 may utilize a variety of comparison tools, such as facial recognition, to determine, confirm, or otherwise verify that the user 332b is the registered user 334a. In one embodiment, the verification module 370 is configured to verify the user's profile 334a by comparing the at least one reference image 336a and a registered biomarker 338 to the input content stream 370 and a user biomarker. In one embodiment, the verification module 370 is configured to verify the profile user's 334a by comparing the at least one reference image 336a and the input content stream 370 and authenticating the user input with the previously saved credentials from the profile 334a. In one embodiment, the verification module 370 includes a notification to the user 332b when the verification module 370 cannot authenticate the user 332b. The notification to the user 332a may be an approval notice or alternatively an error or failure to authenticate notice.

In one embodiment, the verification module 350 is configured to continuously compare the input content stream 370 to the at least one reference image 336a for ongoing authentication. In some examples, continuously comparing the input content stream 370 to the at least one reference image 336a, refers to the verification module 350 running without an interruption or delay or any requirement for user intervention. In another example, continuous refers to the real time analyzation of the input content stream 370 in comparison to the at least one reference image 336a. In one embodiment, the verification module 350 is configured to periodically (e.g., a certain time intervals, such as every second, every ten seconds, every minute, five minutes, etc. or frame based, such as every frame, every twenty frames, etc.) compare the input content stream 370 to the at least one reference image 336a for ongoing authentication. In one embodiment, upon a failed authentication of the user 332b by the verification module 350, the apparatus discontinues until the user 332b reactivates the authentication apparatus 104. In one embodiment, the discontinuation of the authentication apparatus 104 results in outputting the input content stream 370. In one embodiment, the discontinuation of the apparatus results in outputting an image. In one embodiment, the image is the reference image. In one embodiment, upon a failed authentication of the user 332b by the verification module 350, the apparatus generates an error message in response to the at least one reference image 336a associated with the first user 332a not matching the at least one image of the second user 332b. In one embodiment, upon failed authentication of the user 332b, the apparatus generates an error message and/or outputs the input content stream 370. In some embodiment, the apparatus response can be determined by the user 332a in the registration module 330, e.g., the user may select that if verification fails then the output is the input content stream or a copy of the reference image. In another embodiment, the image a pre-selected image based on the user profile 334. In yet another embodiment, the output image from a disconnection includes text such as the user's name with or without an image. In another embodiment, the discontinuation of the apparatus results in closing the authentication apparatus 104 and restarting the authentication apparatus 104. In yet another embodiment, the discontinuation of the authentication apparatus 104 results in a temporary or permanent disconnection from the video conference the user is attending. In some embodiments, in response to a failed authentication of the user 332b, the verification module 370 may attempt to reauthenticate the user a limited number of times before providing an error and/or discontinuing the authentication apparatus 104.

In one embodiment, the generation module 360 is configured to generate at least one AI composition that modifies the input content stream 370 based on the at least one reference image 336a to generate an output content stream 380. In one embodiment, the AI composition may refer to a modification of the output of an image/video from a camera that is not placed perpendicular to a horizontal centerline (e.g., too high/low) to correct for skewness in the output and make the output rectangular/square instead of having a trapezoidal perspective. In other words, when capturing images/video from an overhead camera perspective, there can be distortion that causes rectangular/square objects to appear trapezoidal due to the angle of the camera. To compensate for the distortion and restore the correct proportions, an AI composition is applied to digitally adjust or enhance the image/video and correct the distortion to match the at least one reference image 336a.

In one embodiment, the AI composition may include the generation of a map overlay of the at least one reference image 336a by the generation module 360. The generation module 360 modifies the input content stream 370 using the map overlay to create AI composition used in the output content stream 380. In one embodiment, a map overlay may include mapping facial features from the at least one reference image 336a to the facial features of a user 332b from the input content stream 370. The map overlay may further include animating the facial features from the at least one reference image 336a to have identical facial expressions and facial movements from the user 332b in the input content stream 370. Thus, the output content stream 380 is a video of the at least one reference image 336a that has the facial expressions and facial movements of the input content stream 370. In one embodiment, the generation module 360 may create a map overlay for many aspects of the at least one reference image 336a. For example, the at least one reference image 336a may be a headshot of a user 332b and the generation module 360 will use the AI composition to generate an output content stream 380 in which the user 332b appears to be in attire of the reference image, have the same hairstyle and visual appearance as the at least one reference image 336a, and/or the like.

In one embodiment, the AI composition may include corrections and enhancements of the input content stream 370 based on the at least one reference image 336a. In one embodiment, the generation module 360 may enhance the video quality of the input content stream 370 to be the same resolution quality as the at least one reference image 336a. In one embodiment, the AI composition of the generation module 360 may refer to enhancements of the input content stream 370 such as generating a seamless output content stream 380. The generation of a seamless output content stream 380 may include the frame rate smoothing and/or sharpening and noise reduction of the input content stream 370. In one embodiment, AI composition of generation module 360 is an enhancement of the input content stream 370 which includes AI face retouching, e.g., smoothing skin, enhancing eyes, and improving facial clarity.

In another embodiment, the generation module 360 may generate and enhance video for image lapses or lag in the input content stream 370 such that other members of the video conference would not see a video stream that has lapsed or lagged due to poor image/video quality of the input content stream 370. In one embodiment, the AI composition of the generation module 360 may refer to enhancing and correcting the lighting of the input content stream 370 to have the same appearance as the at least one reference image. In one embodiment, the AI composition of the generation module 360 may refer to the removal of unwanted objects, people, and/or background distractions from the input content stream 370. In another embodiment, the AI composition of the generation module 360 may refer to the stabilization, or reduction of shaking, of the input content stream 370. Further, the generation module 360 may apply any number of filters, corrections, enhancements, or other photo and video adjustments known in the art to generate an improved output content stream 380.

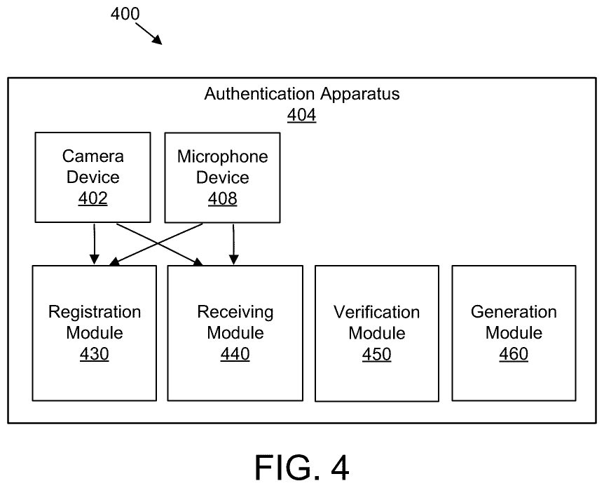

FIG. 4 is a schematic block diagram illustrating one embodiment of an apparatus 400 for techniques for verifying users in a content stream. In one embodiment, the registration module 430 and receiving module 440 rely solely on the local camera device 402 and local microphone device 408 to register a user 332a and receive the input content stream 370. In one embodiment, the registration module 430 begins when the authentication apparatus 404 initiates. The user 332 registers an initial photo of the user 332 taken by the local camera device 402 to be the at least one reference image 336a at the beginning of the video conference. The receiving module 440 captures video of the user 332 in the input content stream 370 of the local camera device 402 and microphone device 408. The verification module 450 compares the initial photo, registered as the at least one reference image 336a, to the input content stream 370 to authenticate the user is the same as when the video conference began. Upon authentication by the verification module 480, the generation module 460 may enhance and correct the input content stream 370 based on the at least one reference image 336a to generate an output content stream 380.

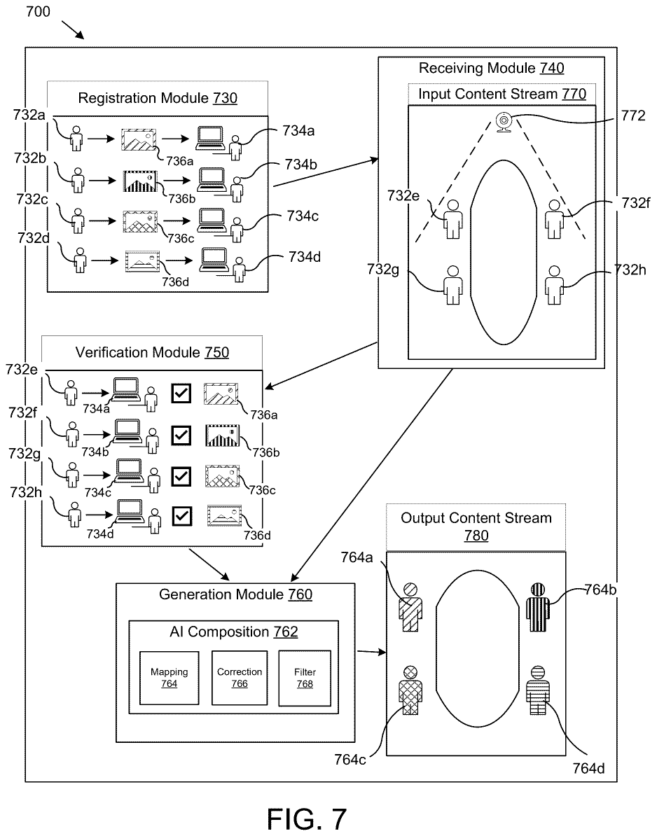

FIG. 7 is a schematic block diagram illustrating one embodiment of a system 700 for techniques for verifying users in a content stream. In one embodiment, the system 700 includes one or more of a registration module 730, a receiving module 740, a verification module 750, and a generation module 760. In one embodiment, the registration module 730 registers at least four users 732a-d with corresponding reference images 736a-d to corresponding profiles 734a-d. The receiving module 740 includes an input content stream 770. The input content stream 770 is captured by a camera device 772. The camera device 772 is a mounted camera which may be found in a conference room and captures video for at least a portion of the conference room.

The input content stream 770 identifies four users 732e-h. The verification module 750 authenticates each user 732e-h against the registered profiles 734a-d. The verification module 750 may further identify the corresponding reference image for each user and profile. The generation module 760 receives the authentication information from the verification module 750 and input content stream 770. The generation module 760 includes an AI composition 762 which may include any number of modifications including mapping 764 facial features of users, correction tools 766, and filter tools 768, to enhance and modify the output content stream 780 as previously described above. As shown in FIG. 7, the output content stream 780 has a modified the appearance of each user 764a-d based upon the corresponding reference image 736a-d. FIG. 7 illustrates a system in which multiple users simultaneously utilize the techniques for verifying users in a content stream described herein. In some embodiments, users 732an-n are a group participating for a video conference and are all gathered together in one room which can host the users 732a-n, these rooms include a conference room, an office, a classroom, a lecture hall, and/or any other room in which users 732a-n may gather for a video conference.

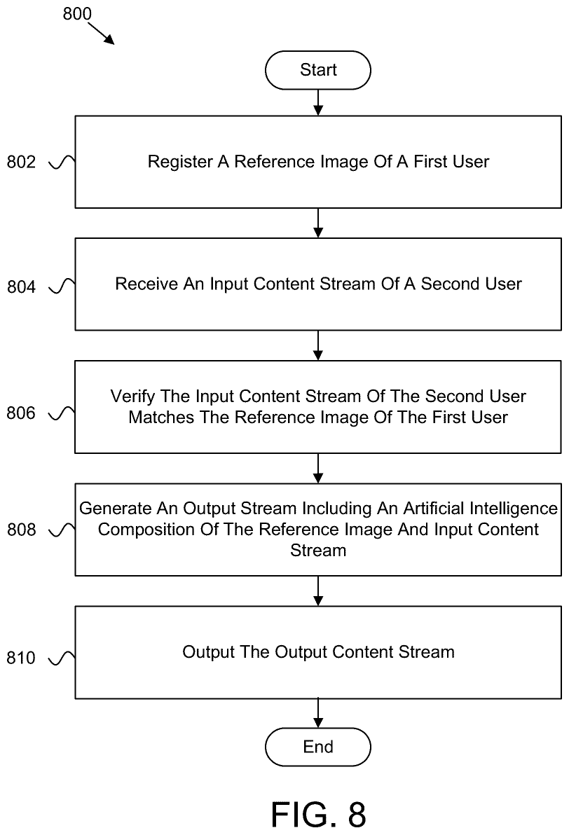

FIG. 8 is a schematic flow chart diagram illustrating one embodiment of a method 800 for techniques for verifying users in a content stream. In one embodiment, the method 800 may be performed by an authentication apparatus 104, on an end-user device, on a server, or a combination thereof. In one embodiment, the method 800 begins and registers 802 a reference image of a first user and receives 804 an input content stream of a second user. The method 800, in one embodiment, verifies 806 the input content stream of the second user matches the reference image of the first user and generates 808 an output content stream, including an AI composition of the reference image and the input content stream, and outputs 810 the output content stream, and the method 800 ends.

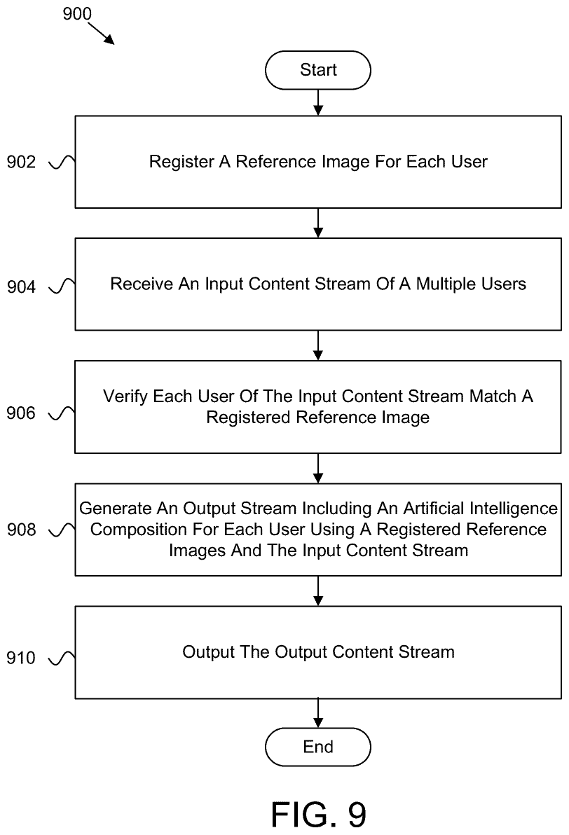

FIG. 9 is a schematic flow chart diagram illustrating one embodiment of a method 900 for techniques for verifying users in a content stream. In one embodiment, the method 900 may be performed by an authentication apparatus 104, on an end-user device, on a server, or a combination thereof. In one embodiment, the method 900 begins and registers 802 a reference image for each user and receives 904 an input content stream of multiple users. The method 900, in one embodiment, verifies 906 that each user of the input content stream matches a registered reference image and generates 908 an output content stream, including an AI composition for each user using the reference images and the input content stream, and outputs 910 the output content stream, and the method 900 ends.

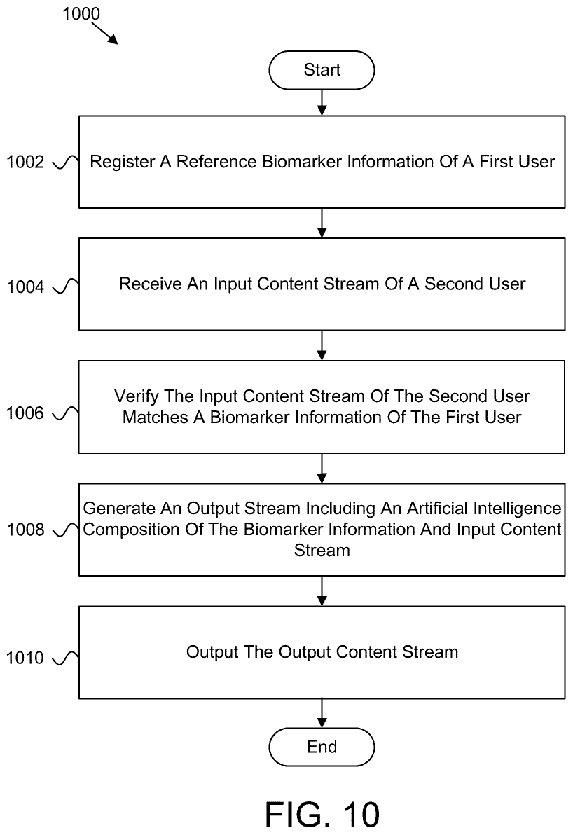

FIG. 10 is a schematic flow chart diagram illustrating one embodiment of a method 100 for techniques for verifying users in a content stream. In one embodiment, the method 1000 may be performed by an authentication apparatus 104, on an end-user device, on a server, or a combination thereof. In one embodiment, the method 1000 begins and registers 1002 biomarker information of a first user and receives 1004 an input content stream of a second user. The method 1000, in one embodiment, verifies 1006 that the input content stream of the second user matches the biomarker information of the first user and generates 1008 an output content stream, including an AI composition of the biomarker information and the input content stream, and outputs 1010 the output content stream. In one embodiment, the biomarker information includes a voice recording of the user and at least one image. In one embodiment, the AI composition animates a reference image of the user based on the voice input of an input content stream so that the output includes a video of a reference image based upon the voice input of the input content stream, and the method 1000 ends.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
a memory; and
a processor coupled with the memory and configured to cause the apparatus to:
register at least one reference image associated with a first user;
receive an input content stream comprising at least one image of a second user;
verify that the at least one reference image associated with the first user matches the at least one image of the second user;
generate an output content stream comprising an artificial intelligence composition of the at least one reference image associated with the first user and the input content stream; and
output the output content stream.

2. The apparatus of claim 1, wherein the processor is configured to cause the apparatus to register the at least one reference image by uploading the at least one reference image from the memory.

3. The apparatus of claim 1, wherein the processor is configured to cause the apparatus to enhance the input content stream to match an image quality of the at least one reference image associated with the first user.

4. The apparatus of claim 1, wherein the processor is configured to cause the apparatus to receive biomarker information for the first user and register the biomarker information by associating the biomarker information with the at least one reference image associated with the first user.

5. The apparatus of claim 4, wherein the biomarker information comprises a voice recording of the first user.

6. The apparatus of claim 4, wherein the biomarker information comprises a fingerprint of the first user.

7. The apparatus of claim 1, wherein the processor is configured to cause the apparatus to verify that the at least one reference image associated with the first user matches the at least one image of the second user by performing a facial recognition comparison of the at least one reference image associated with the first user and the at least one image of the second user.

8. The apparatus of claim 1, wherein the input content stream is captured using a local camera device of the apparatus.

9. The apparatus of claim 1, wherein the artificial intelligence composition further comprises a map overlay of the at least one reference image associated with the first user and the input media stream.

10. The apparatus of claim 9, wherein the artificial intelligence composition further comprises a selection of the at least one reference image to be used in the map overlay.

11. The apparatus of claim 1, wherein the processor is configured to cause the apparatus to generate an error message, output the input content stream, or a combination thereof in response to the at least one reference image associated with the first user not matching the at least one image of the second user.

12. The apparatus of claim 1, wherein the processor is configured to cause the apparatus to continuously verify that the second user is visible in the input content stream.

13. The apparatus of claim 12, wherein the processor is configured to cause the apparatus to output the at least one reference image to the output content stream in response to the second user not being visible in the input content stream.

14. The apparatus of claim 1, wherein the processor is configured to cause the apparatus to continuously verify that the at least one reference image associated with the first user matches the at least one image of the second user.

15. The apparatus of claim 1, wherein the processor is configured to cause the apparatus to periodically verify that the at least one reference image associated with the first user matches the at least one image of the second user.

16. The apparatus of claim 1, wherein the processor is configured to cause the apparatus to:
register at least one reference image associated with a third user;
detect that the input content stream further comprises at least one image of a fourth user;
verify that the at least one reference image associated with the third user matches the at least one image of the fourth user; and
enhance the output content stream by creating an artificial intelligence composition of the at least one reference image associated with the third user and the input content stream.

17. A method comprising:
registering at least one reference image associated with a first user;
receiving an input content stream comprising at least one image of a second user;
in response to verifying that the at least one reference image associated with the first user matches the at least one image of the second user;
generating an output content stream comprising an artificial intelligence composition of the at least one reference image associated with the first user and the input content stream; and
outputting the output content stream.

18. The method of claim 17, wherein the at least one reference image is an image taken by a local camera device.

19. The method of claim 17, wherein registering further includes a biomarker associated with the first user.

20. A computer program product comprising a nontransitory computer readable storage medium storing code, the code being configured to be executable by a processor to perform operations comprising:
registering at least one reference image associated with a first user;
receiving an input content stream comprising at least one image of a second user;
verifying that the at least one reference image associated with the first user matches the at least one image of the second user;
generating an output content stream comprising an artificial intelligence composition of the at least one reference image associated with the first user and the input content stream; and
outputting the output content stream.
